(19) United States
(12) Patent Application Publication
(10) Pub. No.: US 2021/0150613 A1
(43) Pub. Date: May 20, 2021

(54) INFORMATION PROCESSING DEVICE, INFORMATION PROCESSING METHOD, AND INFORMATION STORAGE MEDIUM

(71) Applicant: Rakuten, Inc., Tokyo (JP)

(72) Inventors: Jeremiah Luke ANDERSON, Tokyo (JP); Mohamed Reda Elsayed MOHAMED, Tokyo (JP); Binh NGUYEN, Tokyo (JP); Tariq MUMAN, Tokyo (JP)

(73) Assignee: Rakuten, Inc., Tokyo (JP)

(21) Appl. No.: 17/095,935

(22) Filed: Nov. 12, 2020

(30) Foreign Application Priority Data
Nov. 15, 2019 (JP) 2019-207265

(51) Int. Cl. G06Q 30/06; G06N 20/00; G06Q 30/02

(52) U.S. Cl. CPC G06Q 30/0631; G06N 20/00; G06Q 30/0261; G06Q 30/0252; G06Q 30/0205

(57) ABSTRACT

An information processing device acquires a reference predicted value that is a predicted value of sales figure of a prediction target period and is calculated based on an actual value of sales figure of a past period corresponding to the prediction target period regarding each of target item groups having a trend that sales figures periodically vary in a predetermined repetition cycle; acquires a value of a contextual parameter envisaged to vary in a period shorter than the repetition cycle and affect the sales figures of the target item groups; calculates a difference value between a predicted value of the sales figure of the prediction target period predicted based on the acquired value of the contextual parameter and the reference predicted value regarding each of the target item groups; and selects an item to be recommended to a user based on the difference value calculated regarding each of the target item groups.

### CROSS REFERENCE TO RELATED APPLICATION

This non-provisional application claims priority under 35 U.S.C. § 119(a) on Patent Application No. 2019-207265 filed in Japan on Nov. 15, 2019, the entire contents of which are hereby incorporated by reference.

### BACKGROUND

The present disclosure relates to an information processing device that selects items which are to be recommended to a user, an information processing method, and a program.

Items purchased by users at an online shop or the like may depend on the weather and so forth. Thus, predicting the sales figures of items in consideration of information relating to the weather is being studied (for example, refer to Japanese Patent Laid-Open No. Hei 08-329351).

### SUMMARY

In the case of recommending an item to a user by advertisement or the like, it is not always effective to recommend an item about which the sales figures are predicted to be large by a technique like the above-described one.

The present disclosure is made in view of the above-described circumstances and it is desirable to provide an information processing device that can effectively select items to be recommended to a user, an information processing method, and a program.

An information processing device according to one aspect of the present disclosure includes a reference predicted value acquiring unit that acquires a reference predicted value that is a predicted value of sales figure of a prediction target period and is calculated based on an actual value of sales figure of a past period corresponding to the prediction target period regarding each of a plurality of target item groups having a trend that sales figures periodically vary in a predetermined repetition cycle and a contextual data acquiring unit that acquires a value of a contextual parameter envisaged to vary in a period shorter than the repetition cycle and affect the sales figures of the plurality of target item groups. The information processing device includes also a difference value calculating unit that calculates a difference value between a predicted value of the sales figure of the prediction target period predicted based on the acquired value of the contextual parameter and the reference predicted value regarding each of the plurality of target item groups and a selecting unit that selects an item to be recommended to a user based on the difference value calculated regarding each of the plurality of target item groups.

In the one aspect of the present disclosure, information relating to weather is included in the contextual parameter.

Furthermore, in the one aspect of the present disclosure, the contextual data acquiring unit acquires information relating to weather including a weather forecast of a location of the user as the value of the contextual parameter.

Moreover, in the one aspect of the present disclosure, the difference value calculating unit calculates a predicted value of the sales figure of each of the plurality of target item groups by using a trained model obtained by machine learning using an actual value of the contextual parameter in past and an actual value of the sales figure in past.

Furthermore, in the one aspect of the present disclosure, the selecting unit selects an item that belongs to a target item group about which the calculated difference value is largest in the plurality of target item groups as an item to be recommended to the user.

Moreover, in the one aspect of the present disclosure, the selecting unit selects, as an item to be recommended to the user, a candidate item about which a difference value calculated regarding a target item group to which the candidate item belongs is largest in a plurality of candidate items selected as recommendation candidates for the user.

Furthermore, an information processing method according to one aspect of the present disclosure includes, by a computer, acquiring a reference predicted value that is a predicted value of sales figure of a prediction target period and is calculated based on an actual value of sales figure of a past period corresponding to the prediction target period regarding each of a plurality of target item groups having a trend that sales figures periodically vary in a predetermined repetition cycle and acquiring a value of a contextual parameter envisaged to vary in a period shorter than the repetition cycle and affect the sales figures of the plurality of target item groups. The information processing method includes also, by the computer, calculating a difference value between a predicted value of the sales figure of the prediction target period predicted based on the acquired value of the contextual parameter and the reference predicted value regarding each of the plurality of target item groups and selecting an item to be recommended to a user based on the difference value calculated regarding each of the plurality of target item groups.

Moreover, an information storage medium according to one aspect of the present disclosure is a non-transitory computer-readable information storage medium that stores a program for a computer to execute a process including acquiring a reference predicted value that is a predicted value of sales figure of a prediction target period and is calculated based on an actual value of sales figure of a past period corresponding to the prediction target period regarding each of a plurality of target item groups having a trend that sales figures periodically vary in a predetermined repetition cycle and acquiring a value of a contextual parameter envisaged to vary in a period shorter than the repetition cycle and affect the sales figures of the plurality of target item groups. The process includes also calculating a difference value between a predicted value of the sales figure of the prediction target period predicted based on the acquired value of the contextual parameter and the reference predicted value regarding each of the plurality of target item groups and selecting an item to be recommended to a user based on the difference value calculated regarding each of the plurality of target item groups.

### BRIEF DESCRIPTION OF THE DRAWINGS

FIG. 1 is a configuration block diagram illustrating a configuration of an information processing device according to an embodiment of the present disclosure;

FIG. 2 is a functional block diagram illustrating functions of the information processing device according to the embodiment of the present disclosure;

FIG. 3 is a graph illustrating one example of a transition of sales figures;

FIG. 4 is a data flowchart illustrating a flow of processing executed by a boost value calculating unit;

and

FIG. 5 is a flowchart illustrating one example of a flow of recommending item selection processing.

### DETAILED DESCRIPTION OF THE PREFERRED EMBODIMENT

An embodiment of the present disclosure will be described in detail below based on the drawings.

FIG. 1 is a configuration block diagram illustrating a configuration of an information processing device 10 according to one embodiment of the present disclosure. The information processing device 10 is a server computer or the like and includes a control unit 11, a storing unit 12, and a communication unit 13 as illustrated in FIG. 1.

The control unit 11 includes at least one processor and executes various kinds of information processing in accordance with a program stored in the storing unit 12. A specific example of the processing executed by the control unit 11 will be described later. The storing unit 12 includes at least one memory device such as a random access memory (RAM) and stores a program executed by the control unit 11 and data that is a target of processing based on the program. The communication unit 13 is an interface for connecting to a communication network in a wireless or wired manner. By the communication unit 13, the information processing device 10 is connected to another information processing device in such a manner as to be capable of data communication.

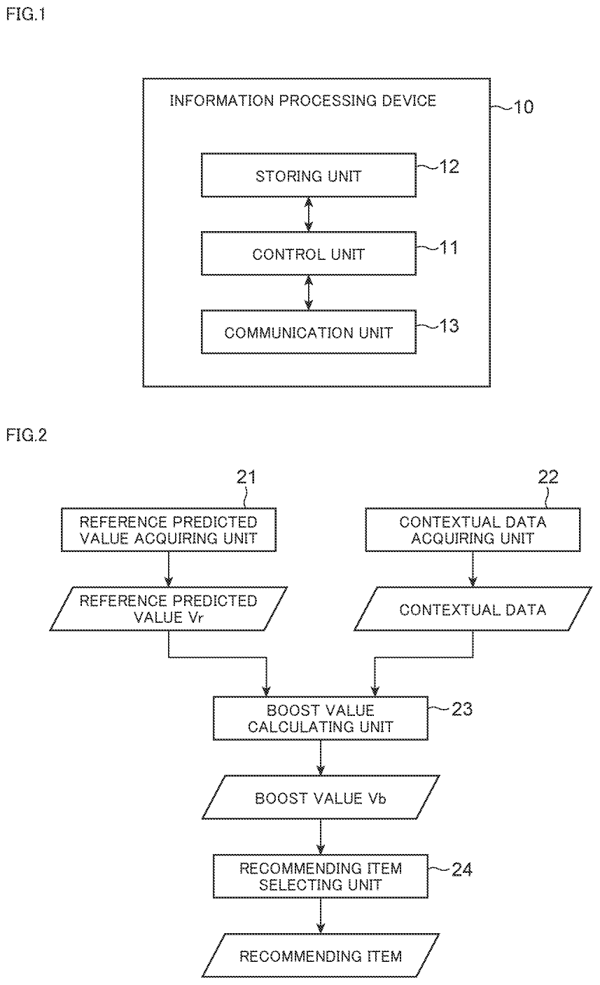

Functions implemented by the information processing device 10 in the present embodiment will be described below by using a functional block diagram of FIG. 2. The information processing device 10 is used for selecting items which are to be recommended to a user at an online shop, online mall, physical store, or the like. In the following, the user that is the target of item recommendation in the present embodiment will be represented as a target user.

As illustrated in FIG. 2, the information processing device 10 functionally includes a reference predicted value acquiring unit 21, a contextual data acquiring unit 22, a boost value calculating unit 23, and a recommending item selecting unit 24. Functions of them are implemented through execution of a program stored in the storing unit 12 by the control unit 11. This program may be provided to the device through a communication network such as the Internet or may be stored in a computer-readable information storage medium such as an optical disc to be provided to the device.

The reference predicted value acquiring unit 21 acquires a reference predicted value Vr that serves as a basis in selecting items to be recommended to the target user regarding each of plural target item groups.

Each target item group is a group composed of one or plural items and is a unit treated as a target of boost value calculation by the boost value calculating unit 23 to be described later. It is desirable that items included in one target item group be items that indicate trends similar to each other regarding variation in the sales figures. Specifically, each target item group may be composed of items having relevance to each other, such as items of the same genre or items of the same brand. Alternatively, each target item group may be composed of only one item in a shop in which the number of items handled is comparatively small, or the like.

As a specific example, in a shopping mall site that handles a wide variety of items, items handled are classified into plural categories and the user can search for an item about each category. Furthermore, these categories may constitute a hierarchical structure with, for example, major classification, middle classification, and minor classification. In such a case, categories of a specific hierarchical level (for example, categories in minor classification) may be used as the target item groups. This can set the target item groups in such a manner that all items with a possibility of being recommended to the target user belong to any target item group.

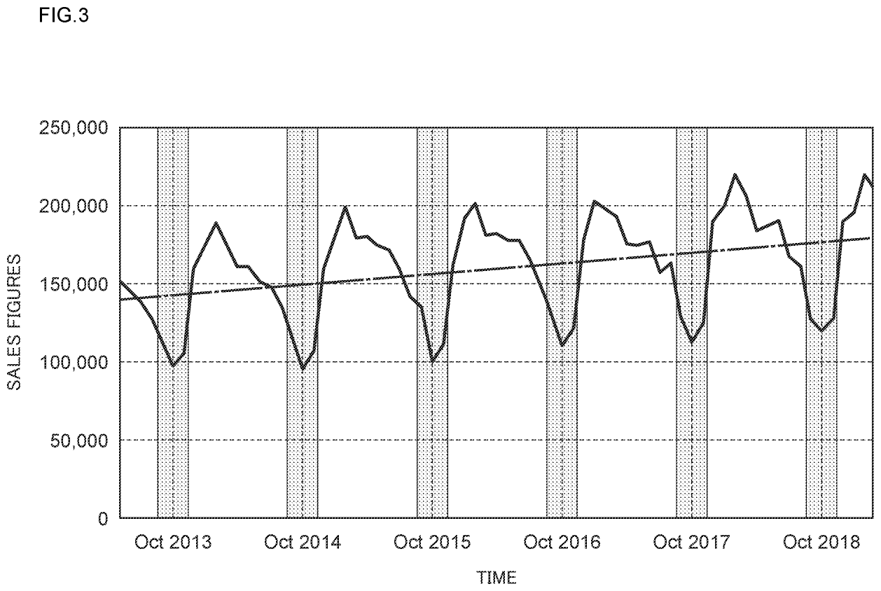

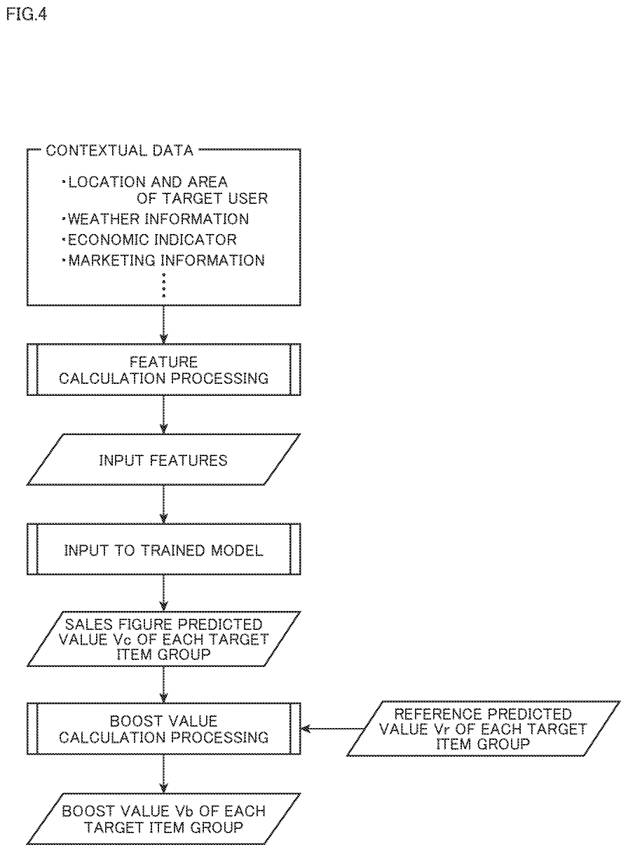

Moreover, in the present embodiment, each target item group has a trend that the total sales figures of the items belonging to the item group periodically vary in a predetermined repetition cycle. In the following, it is assumed that the repetition cycle is one year. It is known that the sales figures of many items periodically vary in units of one year due to the influence of seasonal variation and so forth. FIG. 3 is a graph illustrating a specific example of such variation in the sales figures and indicates the transition of the sales figures of items belonging to a certain target item group in approximately six years. As illustrated in this graph, there is a trend that the sales figures change in a cycle of approximately one year regarding many target item groups.

The reference predicted value Vr is a predicted value of the sales figure in a period for which the prediction is to be performed (hereinafter, referred to as prediction target period) and is a value calculated based on past sales performance (actual value of the sales figures of items actually sold in the past). The prediction target period is a period with a predetermined length including a time in the future from the time when prediction is carried out and may be a day including the time when prediction is carried out or the next day thereof, for example. Here, it is assumed that the length of the period is one day, but the length may be different. Because sales figures of each target item group periodically vary as described above, the sales figure in the prediction target period can be predicted by using data of the sales performance in the past period corresponding to the prediction target period.

Here, the sales figure may be the total sales quantity of items included in each target item group or may be the sales amount (number obtained by multiplying the sales quantity by the unit price). Furthermore, the sales figure may be a value obtained by weighting the sales quantity or sales amount in consideration of the sales volume, the magnitude of the unit price, and so on. Alternatively, the sales figure may be another index value such as the number of orders including items included in each target item group. It is preferable to use the sales quantity as the sales figure. This is because, by using the sales quantity, it can be expected that various items are recommended without a bias toward items with high unit price in selection of recommending items to be described later.

As one example, when the prediction target period is October 1 in the year 2019 and data of the sales performance of the past six years can be used, the reference predicted value acquiring unit 21 acquires data of the sales performance in the period from September 15 to October 15 (that is, one month including the day corresponding to the prediction target period) in each of years from the year 2013 to the year 2018. These periods corresponds to periods hatched in FIG. 3. Then, the reference predicted value acquiring unit 21 predicts the sales figure (here sales quantity) of the prediction target period by dividing the total value of the sales quantity of these periods (six years×31 days) by the number of days to figure out the average value. This figured-out average value of the sales quantity per day is the reference predicted value Vr.

Although the value of the simple arithmetic mean is employed as the reference predicted value Vr here, the configuration is not limited thereto and the reference predicted value Vr may be a value calculated by various calculation expressions using data of past sales performance. For example, for the reference predicted value Vr, first the average value of the sales figure of the period corresponding to the prediction target period may be calculated regarding each year and the sales figure of the prediction target period may be predicted based on the transition of the average values.

The contextual data acquiring unit 22 acquires contextual data in order to predict the sales figure in the prediction target period regarding each of plural target item groups with higher accuracy than the reference predicted value Vr. The contextual data is data including values of contextual parameters. The contextual parameters are parameters whose values vary in a short period compared with the above-described repetition cycle of the sales figures (here one year) and are parameters envisaged to affect the sales figures of the target item group. Specifically, the contextual parameters are information relating to the situation when a shop user performs shopping and are information with a possibility of affecting the mood, willingness to buy, and behavior of the user.

Suppose that the contextual parameters include parameters relating to the weather in the present embodiment. Specifically, the parameters relating to the weather may be wind speed, cloud cover, temperature, moisture, rainfall, and so forth. For example, possibly an online shop is used in order for the user to buy an item at home at the time of rainy weather or the like. Furthermore, when the temperature rises, possibly soft drinks or the like are bought. As above, it is envisaged that the mood and buying behavior of the shop user are affected by short-term variation in the weather. For this reason, it can be expected that the accuracy of prediction of the sales figure is enhanced by using information relating to the weather.

The contextual data that is acquired by the contextual data acquiring unit 22 and relates to the weather may be data obtained by a weather forecast regarding a future period including the prediction target period or may be data that indicates the actual weather in a past period immediately before the prediction target period. These pieces of information may be acquired from an external information provision service through a communication network such as the Internet.

Furthermore, the data relating to the weather may be weather data about a predetermined area (for example, in case of a physical store, location of the physical store). However, when there is a possibility that the locations of users exist over a wide range like users of an online shop, it is desirable to predict the sales figure by using the weather about the location of the target user oneself as the target of recommendation of items. Thus, the contextual data acquiring unit 22 may identify the location of the user and acquire weather data regarding the area as the contextual data.

The location information of the user can be acquired by various methods. For example, the contextual data acquiring unit 22 may refer to address information registered in an online shop by the user oneself or may use location information identified by using information such as the internet protocol (IP) address. Furthermore, when the user accesses the online shop by using a mobile terminal, the present location of the user may be identified with reference to information acquired by a global positioning system (GPS) which the mobile terminal has or connection information of wireless fidelity (Wi-Fi) access point, base station, and so forth.

Furthermore, the contextual data acquiring unit 22 may acquire information on an economic indicator such as the consumer price index as part of the contextual parameters. Furthermore, the contextual data acquiring unit 22 may acquire information relating to marketing activities of the shop. The information relating to marketing activities may be information that indicates whether or not a campaign that is periodically held is being currently held and when the campaign will be held next, or the like, for example.

Moreover, the contextual parameters may include information relating to the situation of the target user oneself. For example, the contextual data acquiring unit 22 may use the above-described location information itself of the target user as the contextual data. Furthermore, the contextual data acquiring unit 22 may use information that indicates the area in which the target user exists, identified based on the location information of the target user, as the contextual data. Here, the information on the area may be information that indicates a prefecture, a district, a state, or a region such as the Northeast region, for example.

The boost value calculating unit 23 calculates the difference value between a sales figure predicted value Vc that is predicted based on the contextual data acquired by the contextual data acquiring unit 22 and the reference predicted value Vr acquired by the reference predicted value acquiring unit 21 regarding each of plural target item groups. Hereinafter, this difference value will be referred to as a boost value Vb.

The sales figure predicted value Vc is a predicted value of the sales figure predicted based on the values of the contextual parameters. In the present embodiment, the boost value calculating unit 23 predicts the sales figure predicted value Vc by using a trained model generated by machine learning in advance. This trained model can be generated by machine learning using a combination of past actual values of the contextual parameters (for example, data of weather, economic indicator, and so forth actually measured in the past) and past sales performance (actual value of sales figures) as data for learning. This machine learning may be implemented by various algorithms and the structure of the model used for the learning may also be various.

More specifically, the trained model is generated by machine learning carried out in the following manner. Specifically, a long period (for example, past ten years) that exceeds the repetition cycle of the sales figures is employed as a learning target period, and data for learning composed of sales performance data of each of plural target item groups in the learning target period and the actual values of the contextual parameters such as the weather of each area and economic indicators in the learning target period is prepared. This data for learning includes information on the actual value of the sales figures of each of plural target item groups on the individual target days included in the learning target period and information (location and so forth) on purchasers who have bought the sold items and information on the actual values of the weather, economic indicators, and so forth of the individual target days. The machine learning is carried out by executing pre-processing for this data for learning if required and inputting the data for learning to a machine learning model prepared in advance.

The actual values of the contextual parameters input to the machine learning model may include information relating to the weather (wind speed, cloud cover, temperature, moisture, rainfall, and so forth) of each target day included in the past learning target period, economic indicators (consumer price index and so forth), the values of parameters relating to campaign information of a shop and so forth. Furthermore, the actual values may include information on the location of the purchaser, the area (district, prefecture, or the like) of the purchaser, and the purchase time (month or the like) regarding individual dealings configuring the sales performance data. By such machine learning, the trained model can be generated that outputs the sales figure predicted value Vc indicating a prediction result of the sales figure of each of plural target item groups in a situation represented by contextual data when the contextual data is input. This model represents the relevance between the values of the contextual parameters such as the weather and the sales figures of each target item group.

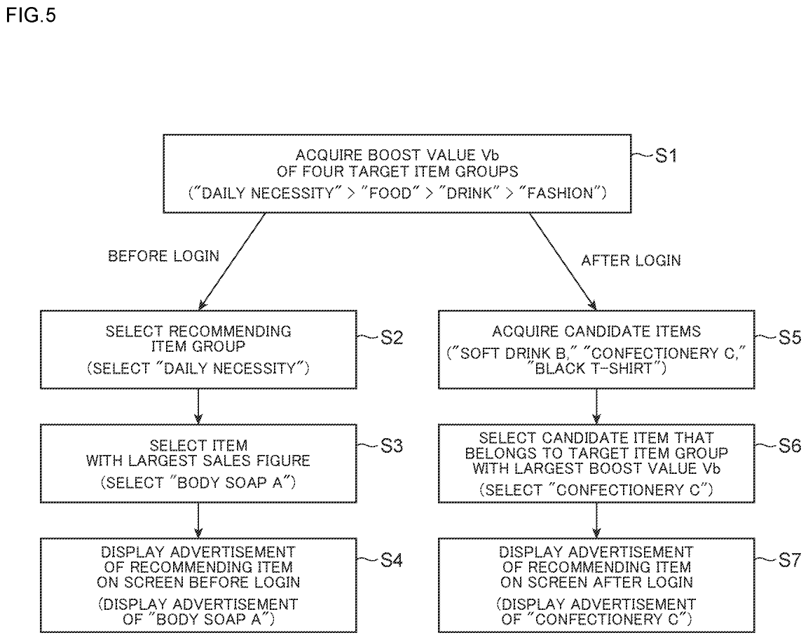

Here, the flow of the processing executed by the boost value calculating unit 23 will be described by using a data flowchart of FIG. 4. The boost value calculating unit 23 inputs the contextual data (location of the target user, weather, economic indicators, and so forth) acquired by the contextual data acquiring unit 22 to the trained model. Suppose that particularly the boost value calculating unit 23 inputs at least forecasted values of the weather (forecasted temperature and so forth of the prediction target period) to the trained model as the contextual data. The boost value calculating unit 23 may execute various kinds of pre-processing, such as scaling and standardization (processing of normalizing the mean and the variance of the respective parameters) and feature engineering, for numerical values of the respective parameters included in the contextual data by using a method generally known in the machine learning and provide the input features obtained from the pre-processing to the trained model. By inputting the input values obtained from the contextual data to the trained model as above, the sales figure predicted value Vc of the prediction target period is calculated regarding each of plural target item groups.

Thereafter, the boost value calculating unit 23 calculates the boost value Vb regarding each of plural target item groups. The boost value Vb is calculated based on the following calculation expression by using the sales figure predicted value Vc obtained by the trained model and the reference predicted value Vr acquired by the reference predicted value acquiring unit 21.

Vb=Vc−Vr

The boost value Vb can become either a positive value or a negative value. In particular, the positive boost value Vb suggests that there is a high possibility that the sales figures increase compared with the sales figures at the same time in the past due to a cause such as the weather. That is, the positive boost value Vb indicates how much the sales figure is likely to temporarily increase due to a short-term cause.

The recommending item selecting unit 24 selects the item to be recommended to the target user (hereinafter, referred to as the recommending item) by using the boost value Vb calculated regarding each of the plural target item groups by the boost value calculating unit 23. As one example, the recommending item selecting unit 24 first selects the target item group including the item to be recommended to the target user (hereinafter, referred to as the recommending item group) from the plural target item groups. Then, the recommending item selecting unit 24 selects one or plural recommending items from the items included in the recommending item group.

Specifically, the recommending item selecting unit 24 may select the target item group having the largest boost value Vb as the recommending item group. As described above, the boost value Vb indicates the possibility that the sales figure increase due to a temporary cause such as the weather. For this reason, larger increase in the sales figure can be expected by recommending the item in the target item group having a large boost value Vb to the target user. By selecting the recommending item group by using the boost value Vb as above, it can be expected that the effect of recommendation to the target user becomes large compared with the case in which merely the target item group with the large sales figure predicted value Vc is employed as the recommending item group.

After selecting the recommending item group, the recommending item selecting unit 24 selects the recommending item from the items included in the recommending item group based on various criteria. For example, the recommending item selecting unit 24 may employ the item having the highest sales performance (the item having the largest sales quantity in a past predetermined period) in the items included in the recommending item group as the recommendation target.

In contrast to the example described thus far, the recommending item selecting unit 24 may first select plural candidate items and select the recommending item from the candidate items by using the boost value Vb. In this case, the candidate items are selected in accordance with a given criterion such as items on sale. Thereafter, regarding each of the candidate items, the recommending item selecting unit 24 refers to the boost value Vb of the target item group to which the candidate item belongs and selects the candidate item about which the boost value Vb is larger than the other candidate items as the recommending item. Also in this example, the recommending item having the comparatively-large boost value Vb (that is, about which increase in the sales figure is expected) can be selected.

Furthermore, regarding each target user, the recommending item selecting unit 24 may decide the recommending item in consideration of the attribute, behavior history, and so forth of the target user. For example, the recommending item selecting unit 24 selects plural candidate items that are likely to be bought by the target user based on information on the attribute, past purchase history, and so forth of the target user. Then, similarly to the above-described example, the recommending item selecting unit 24 selects the candidate item that belongs to the target item group about which the boost value Vb is larger in the selected candidate items as the recommending item.

Moreover, the recommending item selecting unit 24 may execute processing of recommending the selected recommending item to the target user. For example, the recommending item selecting unit 24 displays an advertisement of the recommending item on a website of an online shop viewed by the target user. Here, the recommending item selecting unit 24 may display an advertisement of the recommending item selected irrespective of the target user in the screen before the target user logs in to the website (that is, before the attribute and so forth of the target user oneself are identified). On the other hand, after the target user has logged in to the website, an advertisement of the recommending item selected for the target user is displayed based on the attribute and purchase history of the target user.

As a specific example, an example of recommending item selection processing when the target item groups are four item genres of “daily necessity,” “food,” “drink,” and “fashion” will be described by using FIG. 5. Descriptions in parentheses in this diagram illustrate specific examples of processing results. In this example, first the recommending item selecting unit 24 acquires the boost value Vb calculated regarding each of the four target item groups by the boost value calculating unit 23 (S1). Here, suppose that “daily necessity,” “food,” “drink,” and “fashion” are in decreasing order of the calculated boost value Vb.

When the target user has not logged in to the website, the recommending item selecting unit 24 selects “daily necessity” with the largest boost value Vb, as the recommending item group (S2). Thereafter, the recommending item selecting unit 24 selects, as the recommending item, the item with the largest sales figure in a past predetermined period in the respective items that belong to “daily necessity” selected as the recommending item group (S3). Here, as one example, suppose that the sales figure of an item of “body soap A” are the largest. In this case, the recommending item selecting unit 24 displays an advertisement (or coupon advertisement) of body soap A on the screen of the website before login of the target user (S4). The target user can start a buying procedure of “body soap A” by selecting this advertisement.

On the other hand, when the target user has logged in to the website, the recommending item selecting unit 24 selects candidate items to be recommended to the target user based on account information (login identification (ID) or the like) of the target user input at the time of the login (S5). Specifically, the recommending item selecting unit 24 selects plural candidate items based on attribute information (age, sex, address, and so forth) of the target user associated with the account information, past purchase history information of the target user, and so forth. Here, as one example, suppose that three items of “soft drink B,” “confectionery C,” and “black T-shirt” are selected as the candidate items.

The recommending item selecting unit 24 selects, as the recommending item, the item that belongs to the target item group with the largest boost value Vb in the selected candidate items (S6). In this example, the candidate items “soft drink B,” “confectionery C,” and “black T-shirt” belong to the target item groups “drink,” “food,” and “fashion,” respectively. Here, the candidate item that belongs to “daily necessity” with the largest boost value Vb is not selected and the item with the largest boost value Vb in the candidate items is “confectionery C” belonging to “food.” Thus, the recommending item selecting unit 24 selects “confectionery C” as the recommending item. Then, the recommending item selecting unit 24 displays an advertisement (or coupon advertisement) of “confectionery C” on the screen of the website to which the target user has logged in (S7). When plural candidate items belong to the target item group with the largest boost value Vb, for example, the recommending item selecting unit 24 may select, as the recommending item, the item with the largest sales figure in the plural candidate items that belong to the target item group with the largest boost value Vb similarly to the above-described case of processing before login.

Furthermore, the recommending item selecting unit 24 may execute processing of assisting purchase of the recommending item, such as enabling discount purchase of the recommending item and providing a coupon ticket that can be used at the time of purchase of the recommending item to the target user. By such control, effective increase in the sales figure of the recommending item can be expected.

The information processing device 10 according to the present embodiment acquires a weather forecast of, for example, five days later at a frequency of, for example, one time per day and inputs the contextual data including information on the acquired weather forecast to a trained model to select the recommending item and display an advertisement of the recommending item on a website of the online shop viewed by the target user. Here, the period until the day of the target of acquisition of a weather forecast is set to five days. It is desirable to set this period to a short period so that an item can be recommended according to the temporary mood of the target user and to a period with a certain level of length with which the time taken for purchase action for the item by the target user can be ensured as described later. In a range included in such an idea, the period to the day of the target of acquisition of a weather forecast can be set to one day or ten days, for example. Due to this, improvement in the substantial sales promotion effect can be expected. The way to recommend the recommending item to the target user is not limited to display onto a website. For example, information on the recommending item may be displayed on a screen on an application installed on a user terminal, a screen of a web application, or the like. The frequency of the acquisition of a weather forecast is also not limited to one time per day and the acquisition may be frequently carried out at intervals of one hour or the like, and a weather forecast may be acquired at an arbitrary timing depending on the way of recommendation.

According to the information processing device 10 in accordance with the present embodiment described above, by selecting the recommending item by using the boost value Vb that indicates the amount of increase in the sales figure with respect to the reference predicted value Vr, an item with a high possibility of leading to purchase can be effectively recommended according to the temporary short-term mood of the target user at the time and so forth. As one example, generally beer sells well in the summer. However, if it becomes hot early compared with the average year, people who feel like drinking beer increase and the sales figure of beer may increase at a different timing from the average year, for example, at an earlier timing than the average year. According to the information processing device 10 in accordance with the present embodiment, it becomes possible to provide an advertisement of a specific item in matching with the timing when the sales figure of the item is likely to increase as above. Therefore, it becomes possible to effectively put an item advertisement even in a situation in which there is a limit on advertisement placement, budget, and so forth, and improvement in the sales promotion effect can be expected. In this case, as one example, by using a weather forecast of each area, the time to carry out sales promotion such as an advertisement according to the selected item is ensured and adjustment of a grace time until leading to purchase by the user is allowed and thereby purchase action thereof can be substantially promoted.

Embodiments of the present disclosure are not limited to the embodiment described above. For example, in the above description, it is assumed that the reference predicted value acquiring unit 21 carries out calculation of the reference predicted value Vr regarding each target item group. However, the reference predicted value acquiring unit 21 may acquire the reference predicted value Vr calculated by an external information processing device. Furthermore, in the above description, it is assumed that the boost value calculating unit 23 carries out machine learning and generates trained model. However, the machine learning may be carried out by another information processing device.

Moreover, here it is assumed that the trained model generated by the machine learning is a model that outputs the sales figure predicted value Vc. However, a model that outputs the boost value Vb itself may be generated by the machine learning. In this case, the reference predicted value Vr of each target item group is calculated based on past sales performance data and the difference value between the calculated reference predicted value Vr and the actual sales figure is calculated. Then, this difference value is used as training data and machine learning is carried out. This can generate a machine learning model that provides the boost value Vb of each target item group as output data.

It should be understood by those skilled in the art that various modifications, combinations, sub-combinations and alterations may occur depending on design requirements and other factors insofar as they are within the scope of the appended claims or the equivalents thereof.

What is claimed is:

1. An information processing device comprising:
a reference predicted value acquiring unit that acquires a reference predicted value that is a predicted value of sales figure of a prediction target period and is calculated based on an actual value of sales figure of a past period corresponding to the prediction target period regarding each of a plurality of target item groups having a trend that sales figures periodically vary in a predetermined repetition cycle;
a contextual data acquiring unit that acquires a value of a contextual parameter envisaged to vary in a period shorter than the repetition cycle and affect the sales figures of the plurality of target item groups;
a difference value calculating unit that calculates a difference value between a predicted value of the sales figure of the prediction target period predicted based on the acquired value of the contextual parameter and the reference predicted value regarding each of the plurality of target item groups; and
a selecting unit that selects an item to be recommended to a user based on the difference value calculated regarding each of the plurality of target item groups.

2. The information processing device according to claim 1, wherein
information relating to weather is included in the contextual parameter.

3. The information processing device according to claim 2, wherein
the contextual data acquiring unit acquires information relating to weather including a weather forecast of a location of the user as the value of the contextual parameter.

4. The information processing device according to claim 1, wherein
the difference value calculating unit calculates a predicted value of the sales figure of each of the plurality of target item groups by using a trained model obtained by machine learning using an actual value of the contextual parameter in past and an actual value of the sales figure in past.

5. The information processing device according to claim 1, wherein
the selecting unit selects an item that belongs to a target item group about which the calculated difference value is largest in the plurality of target item groups as an item to be recommended to the user.

6. The information processing device according to claim 1, wherein
the selecting unit selects, as an item to be recommended to the user, a candidate item about which a difference value calculated regarding a target item group to which the candidate item belongs is largest in a plurality of candidate items selected as recommendation candidates for the user.

7. An information processing method comprising, by a computer:
acquiring a reference predicted value that is a predicted value of sales figure of a prediction target period and is calculated based on an actual value of sales figure of a past period corresponding to the prediction target period regarding each of a plurality of target item groups having a trend that sales figures periodically vary in a predetermined repetition cycle;
acquiring a value of a contextual parameter envisaged to vary in a period shorter than the repetition cycle and affect the sales figures of the plurality of target item groups;
calculating a difference value between a predicted value of the sales figure of the prediction target period predicted based on the acquired value of the contextual parameter and the reference predicted value regarding each of the plurality of target item groups; and
selecting an item to be recommended to a user based on the difference value calculated regarding each of the plurality of target item groups.

8. A non-transitory computer-readable information storage medium that stores a program for a computer to execute a process comprising:
acquiring a reference predicted value that is a predicted value of sales figure of a prediction target period and is calculated based on an actual value of sales figure of a past period corresponding to the prediction target period regarding each of a plurality of target item groups having a trend that sales figures periodically vary in a predetermined repetition cycle;
acquiring a value of a contextual parameter envisaged to vary in a period shorter than the repetition cycle and affect the sales figures of the plurality of target item groups;
calculating a difference value between a predicted value of the sales figure of the prediction target period predicted based on the acquired value of the contextual parameter and the reference predicted value regarding each of the plurality of target item groups; and
selecting an item to be recommended to a user based on the difference value calculated regarding each of the plurality of target item groups.
